(19) United States
(12) Patent Application Publication
(10) Pub. No.: US 2017/0316418 A1
(43) Pub. Date: Nov. 2, 2017

(54) LEASED DEVICE OPERATIONS TO A NEARBY DEVICE ON DETECTION OF DEVICE INOPERABILITY

(71) Applicant: PAYPAL, INC., San Jose, CA (US)

(72) Inventor: Pankaj Sarin, New Delhi (IN)

(21) Appl. No.: 15/140,369

(22) Filed: Apr. 27, 2016

(51) Int. Cl. G06Q 20/40; H04W 4/02; H04W 4/00; H04W 4/24; H04L 29/06

(52) U.S. Cl. CPC G06Q 20/40145; H04W 4/24; H04L 63/10; H04W 4/008; H04W 4/023

(57) ABSTRACT

There are provided systems and methods for leased device operations to a nearby device on detection of device inoperability. A device may detect that the device is in danger of failure, for example, if a battery is low on the device, the device is damaged, or the device runs out of available memory for storage and/or application execution. On detection of such a condition, the device may determine current processes a user is currently utilizing. The device may the cause another device to be located at or nearby the device, where the other device may be capable of continuing the processes utilized by the user. The device may then cause a token to be generated that identifies the processes and data for the processes. The token may be communicated to the other device so that on failure of the original device, the user may continue the processes.

### TECHNICAL FIELD

The present application generally relates to device operability and shared computing, and more specifically to leased device operations to a nearby device on detection of device inoperability.

### BACKGROUND

Users may utilize various computing devices, such as tablet computers, mobile smart phones, and wearable computing devices, to perform computing functions while the user is mobile and away from other available computing devices utilized by the user. For example, users may wish to perform payment processes using mobile devices, where the users may provide payment to online or local merchants through the mobile devices. At other times, users may wish to utilize mobile communication devices for communication services, including text messaging, social networking, media sharing, and other types of communications with other users. However, these mobile devices may become at risk of failure, which may be increasingly more likely with higher use and more power-intensive applications. For example, use of a mobile device may decrease a battery powering the mobile device, or put the mobile device at larger risk of damage. At other times, a schedule and/or itinerary of the user may show that a user may be located at an area with low or no signal strength to utilize their mobile device. When such situations occur, the users may be left without device functionality, and thus be prevented of use of their device to continue utilizing processes and applications on the device. Moreover, while other devices may be nearby that a user may utilize, any process or application data lost due to the failure of the user's device may cause repeat entry of data and use of a process, thereby inconveniencing the user and potentially losing valuable data that may be unrecoverable.

### BRIEF DESCRIPTION OF THE DRAWINGS

FIG. 1 is a block diagram of a networked system suitable for implementing the processes described herein, according to an embodiment;

FIG. 2A is an exemplary environment displaying a communication device prior to failure and establishing a token for leased computing on a nearby device, according to an embodiment;

FIG. 2B is an exemplary environment displaying acceptance of leased computing on a nearby device by a communication device in danger of failure, according to an embodiment;

FIG. 2C is an exemplary environment displaying an authentication process to allow for execution of the leased computing processes on a leased device, according to an embodiment;

FIG. 2D is an exemplary environment displaying execution of leased computing processes on a leased device after authentication of a user, according to an embodiment;

FIG. 3 is an exemplary system environment having two communication devices for leased device operations to a nearby device on detection of device inoperability, according to an embodiment;

FIG. 4 is an exemplary process flowchart for leased device operations to a nearby device on detection of device inoperability, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for “leased” or temporarily transferred device operations to a nearby device on detection of device inoperability. Systems suitable for practicing methods of the present disclosure are also provided.

A communication device may be utilized by a user to perform various merchant and payment processes, including shopping, purchase, and other merchant transactions. The communication device may further be utilized to perform other virtual and online actions, such as social networking, messaging and texting, microblogging, media sharing, video game playing, and/or accessing and navigating within a website. The communication device may therefore include one or more software processes to perform the aforementioned actions, which may be included with one or more applications executing on the communication device. Such software processes may be utilized through the hardware features of the communication device, such as the hardware processor, device display and other output devices, network access components, input devices, etc. The communication device may therefore include various hardware and software features. Additionally, the communication device may include additional hardware features that allow execution of the processes, such as a power source (e.g., a battery, power cord for an outlet, etc.).

During use of the communication device, a pending or upcoming condition of non-operation and/or failure of the communication device may be detected. For example, the communication device and/or a service provider may determine the pending, upcoming, future, or predicted conditions, which have yet to happen to the communication device, which may cause failure or non-operation of the communication device. Thus, the condition may correspond to future non-operation or failure of the device at some future time. The future time may be imminent (e.g., within the next few seconds or minutes), may be at a specific future time (e.g., a LOAM local time), or may be within a longer timeframe but prior to the user finishing the current processes the user is utilizing on the device (e.g., failure of the device prior to the user finishing a payment process with another entity). The condition affecting operation or causing failure of the communication device may correspond to a hardware and/or software failure. For example, the condition may be one or more of the following: low battery, no communication signal or low communication signal, structural or hardware damage, software damage or corruption (e.g., malware, a virus, etc.), a software update for the communication device that may affect the current application or processes executing on the communication device, a firmware update, a hardware update or replacement, other types of updates that may require the communication device to power off or restart, lack of memory storage, and/or an application corruption of an application executing on the communication device. Other or different conditions may also be detected that may affect use of the communication device and/or failure of the communication device. In various embodiments, the detection of the condition may be performed by a process executing on the communication device. However, in further embodiments, a server or other device, such as a service provider's server may instead query the device for data and determine the condition.

On detection of the condition indicating a predicted non-operation and/or failure of the communication device, the communication device and/or service provider server may determine the process(es) currently executing on the communication device. The process(es) executing on the communication device may correspond to current processes that the user is utilizing, for example, if the user currently has an application open and is processing data, receiving output, and/or providing input to the application. Thus, the process(es) may correspond to one or more applications currently executing on the communication device. Determination of the process(es) may also correspond to the current process or application data, such as the input by the user to the process/application, processed or processing data, communications and network data transfers, and/or application output. For example, if the user is currently sending or receiving communications, the communications and their data/metadata may be determined. Similarly, if the user is currently in a checkout and payment process with a merchant, the current website/webpage and/or application interface, as well as the transaction and payment data may be determined. The process(es) and process/application data may be stored to the communication device and/or to the service provider's server or device. Where the device has yet to fail, the device may further determine what processes were executing when detecting condition of future failure, and may continue reading the process and process data to update the process/application data as needed. In further embodiments, additional processes and data may further be determined, such as processes executing in the background of the device that the user may utilize or may have data useful or necessary to the user (e.g., communications, map information, etc.).

After detection of the condition affecting upcoming operation of the communication device, the communication device may determine a nearby device that the user of the communication device may lease or otherwise utilize for execution of the process. For example, the nearby device may be utilized to complete the process(es) currently executing on the device and in use by the user. In this regard, in order to detect a nearby device, the communication device may utilize location data (e.g., through a GPS locator) for the communication device and other nearby devices. Such location data may be queried from the service provider or may be retrieved using one or more other processes, including communication with nearby devices. In other embodiments, short range wireless communications may be used to determine and query nearby devices for use and/or lease to process the current processes of the communication device when the communication device fails. Moreover, additional information may further be used to select one of a plurality of nearby devices as the device to utilize and/or lease to complete the processes in the event of failure of the communication device. For example, the user may set preferences for selection of the nearby device, such as device features and/or applications, device type, known or trusted users, security features, etc. Such preferences may be set with the communication device and/or the service provider. Where another user in possession of the nearby device requests payment for use and lease of the device, the nearby device may be selected based on preferences set by the user for payment (e.g., cost, payment method, etc.) or may be selected as the least expensive device to lease. Additionally, the nearby device may also be selected based on the applications available on the nearby device, which may include the application(s) required for use and completion of the process of the communication device, as well as other applications (e.g., communication, payment, and/or authentication applications). In various embodiments, a plurality of nearby devices may be presented to the user of the communication device, where the user selects one of the nearby devices, for example, based on fee data, location, owner of the nearby device, etc. In various embodiments, the first communication device may not fail, however, another communication device may still be selected for processing and may complete the processing.

Once the nearby device is determined, the communication device may cause a token to be generated that allows for the nearby device to execute the process(es) detected on the communication device at or near the time of non-operation or failure. In this regard, the communication device may generate the token, for example, through an application on the communication device. In other embodiments, the service provider may generate the token. The token may include the currently executing process(es) detected on the communication device when or after the condition of future non-operation occurs, as well as the application data. In this regard, the token may correspond to a package of data, where use of the token loads the process(es) and the associated data. However, in other embodiments, the process(es) executing on the communication device at the time of non-operation and the application data may be stored to another server/device, such as the service provider, where the token identifies the stored data and allows for retrieval and loading of the process(es) and application data. Additionally, the token may include token validity, such as a time period for use of the token and/or executing the process(es) and associated data on the nearby device. The token may be limited to use on the nearby device or other devices authorized or approved by the user of the communication device. The token may further include an authentication mechanism associated with the user of the communication device, which may be required to be entered to the nearby device to load or use the token, thus requiring authentication to execute the process(es) of the communication device on the nearby device. For example, the authentication mechanism may correspond to a user name and password for the user, for an account with the service provider, and/or for the communication device. The authentication mechanism may also include a fingerprint or other biometric to validate the identity of the user. Once the token is generated, the user's communication device may display or otherwise output the information for the token, the authentication, and the nearby device to the user prior to failure of the communication device. The communication device may also display information about the other user for the nearby device, as well as any fees required and processes to pay for the fees. Thus, the user of the communication device may utilize the information to find the other user and the nearby device, as well as contact the other user (e.g., through a messaging name, phone number, etc.) The communication device may further provide information on the failure of the communication device, and a time or other parameter until failure (e.g., battery level).

Once the token is generated, the token may be communicated to the nearby device. The communication device or the service provider may communicate the token to the nearby device. Thus, when the communication device fails or otherwise becomes inoperable, the nearby device may be utilized to continue the process(es) that was executing on the communication device at the time of failure. The nearby device may receive the token, and may store the token for use when the user retrieves the nearby device. The user may be required to be authenticated on the nearby device using the authentication mechanism selected for the token. Once the user retrieves the nearby device (and authenticates the user's identity on the nearby device), the nearby device may process the token and load the application or other process, as well as any application or process data. For example, where the token includes data for a merchant application, where the user was purchasing an item, the token may load the merchant application and provide an interface for the application having the data entered by the user to the purchase process. The nearby device may thereby continue the processes of the communication device being performed by the communication device when it failed. The nearby device may utilize data within the token to load the process and associated data, or may utilize the token to retrieve the process and associated data from the service provider using the token. The nearby device may further display to the other user of the nearby device the request for lease of the device. The other user may therefore decline leasing the nearby device to the user of the communication device. The other user may also utilize the information for the lease request and the token to locate the user of the communication device, and provide the nearby device for use to the user. The nearby device may also present other information allowing the other user to communicate with the user of the communication device, such as a contact number and time until failure of the communication device, as well as any agreed fee and payment process for the fee.

Where the nearby device does not currently have the application or other software necessary for continuing or completing the process of the communication device, the nearby device may download the application on receipt of the token and/or authentication of the user to utilize the process. The nearby device may request approval from the other user of the nearby device to download the application. Moreover, where available memory space is an issue, the other user may select applications or data to delete, or the user of the communication device may be notified of the potential issue. Thus, the token may be transmitted to another nearby device by the communication device, the service provider, and/or the nearby device originally receiving the token when the token cannot be processed by the nearby device, for example, due to lack of the application or necessary software, hardware constraints, potential failure, or other condition. After processing of the process(es) associated with the token, the application may be deleted, automatically or manually by the other user. Additionally, the token, process(es), and associated data may also be removed and/or deleted from the nearby device after processing, e.g., automatically when the process(es) are completed or when the user of the communication device terminates the lease arrangement with the nearby device.

When the user authenticates the nearby device and/or begins utilizing the process(es) on the nearby device (e.g., utilizes the token on the nearby device), processes and associated data on the nearby device for the application executing the process(es) associated with the token may be stored by the nearby device. For example, if the token utilizes a messaging application on the nearby device, previous messages for the other user of the nearby device in the messaging application and/or received messages for the other user during use of the messaging application by the user of the failed communication device may be stored by the nearby device. Thus, once the process(es) are completed on the nearby device, the previous data for the nearby device and the other user of the nearby device may be retrieved and loaded back to the application. Additionally, any data for the other user in the application may be protected from the user so that the other user's sensitive data is not shown to the user during use of the nearby device.

After use of the nearby device, the user may be required to pay the other user of the nearby device for use of the nearby device. The user may provide payment using a payment provider, such as the service provider, or may provide physical payment (e.g., cash) to the other user. The user may utilize an online payment account to provide payment. The user's payment account may be automatically debited for the payment on use of the token on the nearby device. The payment process may also be loaded for processing on the nearby device on use of the nearby device by the user. The payment may only be processed at the end of use of the nearby device, or may be provided on initial loading of the process(es) and/or token on the nearby device. Once the user is finished using the nearby device, any data loaded and/or processed using the nearby device may be deleted and removed from the nearby device. Additionally, the authentication mechanism may be removed, and the nearby device may be reverted to a state prior to executing the process(es) and the token. Additionally, the user and/or the other user of the nearby device may end the process(es) manually, such as through an application interface command or option, which may occur prior to completion of the process(es). Based on the premature ending of the process(es), payment may be processed accordingly, such as a partial payment or no payment.

As previously discussed, an online service provider may provide services to users of the online service provider, as well as other entities requesting additional services, such as account providers (e.g., payment service providers, financial institutions, online social networks, media sharing services, and other types of services where a user may utilize an account with the service provider). The service provider may provide the features and services previously discussed in reference to the communication device. Thus, the online service provider may also provide the aforementioned procedures to determine a device is in danger of failing, generate a token for a nearby device to continue the processes on the nearby device, and facilitate transmission of the token to the nearby device. Additionally, the service provider may provide account services to the user, where the user may establish and maintain an account to utilize services of the service provider. For example, an online payment provider or other transaction processing entity may provide payment processing, monetary transfer, and other financial services to merchants, consumers, and other users, which may be utilized through one or more applications executing on a user device of the user (e.g., browser/dedicated application) and an account of the user with the payment provider. The service provider may further include additional transaction management services accessible through a device application, such as a browser application, dedicated application of the service provider, and/or other application (e.g., merchant application) utilizing the processes and features provided by the service provider. Accounts with the service provider may correspond to user accounts, where a holder of the account may utilize services of the service provider through the account. The accounts of users may include personal, device, and financial information, as well as other information that may be determined by or requested from the service provider. Additionally, the user may specify authentication credentials, such as a login name, password, and/or personal identification number (PIN) for use of the account. The authentication credentials may allow the user to verify their identity and/or access the account, for example, through a universally unique identifier, token, password, PIN, or other identifier.

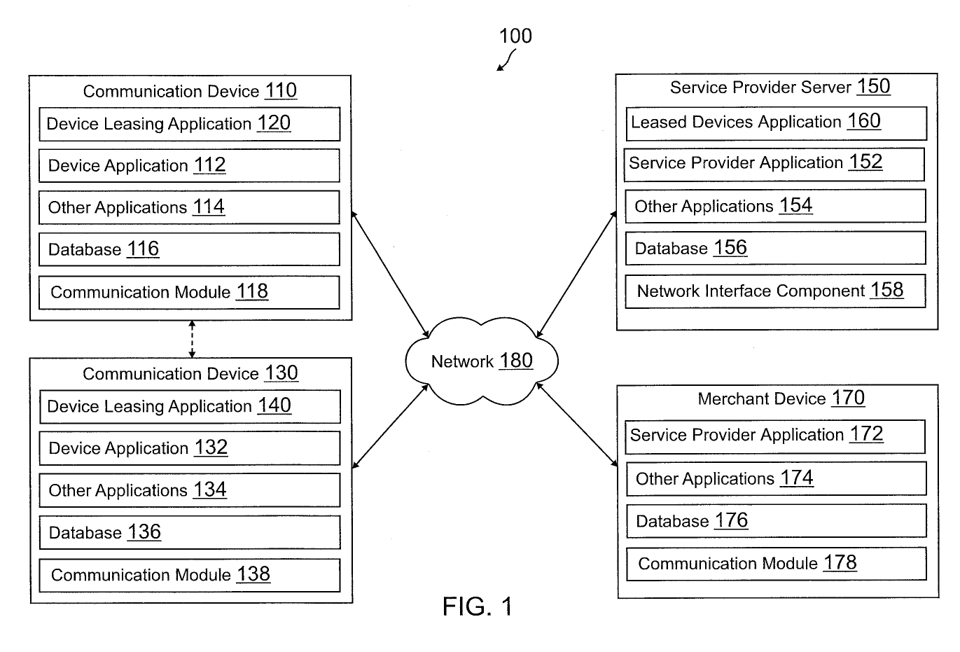

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a communication device 110, a communication device 130, a service provider server 150, and a merchant device 170 in communication over a network 180. A first user (not shown) may utilize communication device 110 to request a lease of communication device 130 from a second user (not shown) to execute and/or complete processes of communication device 110 in the event of failure of communication device 110. Communication device 110 may detect a condition of future non-operation and/or failure of communication device 110, and determine processes currently in use by the first user on communication device 110. In various embodiments, the process may correspond to a process with merchant device 170, such as a transaction to purchase an item. Communication device 110 may determine communication device 130 is the leasing device, for example, using short range wireless communications and/or location detection services (e.g., GPS). In various embodiments, service provider server 150 may facilitate determination of communication device 130 as the leasing device. Once detected, communication device 110 may cause a token to be generated, for example, by communication device 110 and/or service provider server 150. The token may allow for retrieval of the processes that were currently in execution by communication device 110, and any process data. The token may be communicated to communication device 130, which may utilize the token to execute and/or complete the processes of communication device 110 in the event of failure of communication device 110.

Communication device 110, communication device 130, service provider server 150, and merchant device 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 180.

Communication device 110 may be implemented as a communication device that may utilize appropriate hardware and software configured for wired and/or wireless communication with communication device 130, service provider server 150, and/or merchant device 170. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Communication device 110 may correspond to and be utilized by a first user, such as a lessee or requestor for communication device 110. In this regard, communication device 110 may correspond to a failing device or a device predicted to fail or become non-operational with respect to a specific process being handled by the device, generally a device that may not be able to complete a current or predicted process or operation, where operations, processes, and executable code may be continued through use of communication device 130. Although a communication device is shown, the communication device may be managed or controlled by any suitable processing device. Although only one communication device is shown, a plurality of communication devices may function similarly.

Communication device 110 of FIG. 1 contains a device leasing application 120, a device application 112, other applications 114, a database 116, and a communication module 118. Device leasing application 120, device application 112, and other applications 114 may correspond to executable processes, procedures, and/or applications with associated hardware. In other embodiments, communication device 110 may include additional or different modules having specialized hardware and/or software as required.

Device leasing application 120 may correspond to one or more processes to execute modules and associated devices of communication device 110 to determine that communication device 110 is failing, will become inoperable, or is in danger of failing or becoming inoperable. Where a condition indicating future non-operation or failure of the device is detected, device leasing application 120 may further initiate and execute a process to lease communication device 110 for use of processes currently executing on communication device 110 at the time of failure. In this regard, device leasing application 120 may correspond to specialized hardware and/or software utilized by communication device 110 to first determine that communication device 110 will fail or become in-operable, or is susceptible to failure or non-operation. Device leasing application 120 may correspond to a general browser application configured to retrieve, present, and communicate information over the Internet (e.g., utilize resources on the World Wide Web) or a private network. For example, device leasing application 120 may provide a web browser, which may send and receive information over network 180, including retrieving website information, presenting the website information to the user, and/or communicating information to the website. However, in other embodiments, device leasing application 120 may include a dedicated application of service provider server 150 or other entity (e.g., payment provider, etc.), which may be configured to provide services through the application.

In this regard, a condition of communication device 110 may be detected, where the condition indicates a likelihood that the first user of communication device 110 will no longer be able to utilize communication device 110 in the future (e.g., within a set time frame, such as the next minute, 5 minutes, etc., or within another parameter, such as 5% remaining battery, travel to a location with no signal, etc.). The condition may be one or more of low battery, no communication signal or low communication signal, structural or hardware damage, software damage or corruption (e.g., malware, a virus, etc.), a software update for the communication device that may affect the current application or processes executing on the communication device, a firmware update, a hardware update or replacement, other types of updates that may require the communication device to power off or restart, lack of memory storage, and/or an application corruption of an application executing on the communication device. The condition may be detected using the hardware, operating system, and other processes and applications of communication device 110. For example, device leasing application 120 may query one or more processes of communication device 110 to detect the condition, or may utilize an application programming interface (API) of device leasing application 120 to make system calls to various system resources to determine the condition. Once detected, device leasing application may alert the first user of communication device 110, as well as, in various embodiments, service provider server 150.

The first user may request that device leasing application 120 begin a process to utilize or lease a nearby device (e.g., communication device 130) to execute and/or complete processes currently in execution on communication device 110, for example, processes the first user is currently utilizing and would like to finish. In other embodiments, device leasing application 120 may automatically begin the process to utilize or lease a nearby device. Device leasing application 120 may determine processes currently in execution by communication device 110, which may correspond to all processes executing on communication device 110 at or nearby the time or condition of failure/non-operation, or a subset of the processes. For example, device leasing application 120 may determine applications and application processes executing both in the foreground and background of the operating system. However, in other embodiments, device leasing application 120 may limit the detected processes to those currently in use by the first user of communication device 110, such as an application currently executing in the foreground by the user and in use by the user (e.g., receiving user input, providing output to the user, and/or processing data). Once processes in execution (e.g., applications and application processes executing on communication device 110) are detected, device leasing application 120 may further determine any necessary process and/or application data, such as current data entered into the process, received data for the process, and user input data to the process. The process(es) and associated data may be stored to database 116 of communication device 110 for association with a token and communication to a nearby device, or data for the process(es) and associated data may be communicated to service provider server 150 to retrieval by the nearby device using a generated token. In various embodiments, device leasing application 120 may continue tracking the process(es) and updating the information for the process(es)/data up to the point of failure/non-operation of communication device 110.

After determination of data necessary to identify the process(es) and associated data currently in execution by communication device 110, device leasing application 120 may be used to determine a nearby device to utilize or lease for purchase of executing and/or completing the process(es) with the associated data. In this regard, device leasing application 120 may select communication device 130 as the nearby device to utilize or lease. Device leasing application 120 may perform the selection based on received information for nearby devices from communication device 130 and/or service provider server 150. In other embodiments, service provider server 150 may select a nearby device, such as communication device 130, based on information received from communication device 110 and/or communication device 130. For example, communication device 130 may be selected as the nearby device to utilize or lease based on received geo-locations for communication device 110 and/or communication device 130 (e.g., GPS coordinates or locations, addresses or map locations, etc.). In other embodiments, communication device 110 and communication device 130 may detect each other and/or communicate for purposes of device selection and token transfer using short range wireless communications, such as Bluetooth, Bluetooth Low Energy, radio, infrared, WiFi, near field communications, LTE Direct, or other short range communication protocol. Moreover, device capabilities for communication device 130 may be utilized to select communication device 130 as the nearby device, such as hardware specifications and benchmarks, currently installed and available applications, operability requirements (e.g., battery level, signal availability, etc.), and/or available memory and processing requirements.

The first user of communication device 110 and/or a second user for communication device 130 may also set preferences for selection of communication device 130 as the nearby device, for example, preferences for a lease cost, a blended or unblended fee (e.g., a flat use cost, a use over time cost, a use over data usage cost, or other fee arrangement), location or travel distance, user information (e.g., age, gender, etc.), device capabilities, device software, signal strength and/or data transfer speed, etc. Where a plurality of nearby devices are detected, the plurality may be presented to the first user of communication device 110 so that the first user may select communication device 130 and/or the second user for communication device 130 as the nearby device. Device leasing application 120 may display or otherwise provide information for communication device 130 and/or the second user for communication device 130 to the first user through an output component of communication device 110. The information may allow the first user to locate the second user, such as a map location, landmark, image of the second user, name, contact information, meeting place, or other user, location, or device information. Where a plurality of nearby devices and/or users is presented, the user may be provided information for each user/device to better allow selection of a nearby device, such as communication device 130.

Device leasing application 120 may cause a token to be generated once communication device 130 is selected as the nearby device. The token may include or identify the information and other data for the process(es) executing on communication device 110 at or nearby a time of failure/non-operation. For example, the token may be used to initiate, execute, and/or complete the process(es) and associated data determined by device leasing application 120 to be in use by the first user of communication device 110 and/or executing on communication device 110 when the condition of future failure or non-operation is detected. The token may be generated directly by device leasing application 120, or may be generated by service provider server 150 on request by device leasing application 120. In various embodiments, the token may correspond to an identifier (ID), such as a universally unique identifier (UUID), that uniquely identifies the information for the process(es) and associated data stored with communication device 110 and/or service provider server 150. In such embodiments, the token may therefore only include the ID, or may include the ID with a process to activate communication device 130 and initiate a leasing process (as well as include leasing information, such as information for the first user). However, in other embodiments, the token may correspond to a larger data package, which may include the information and other data for the process(es) and associated data determined to be in use on communication device 110 at the time of detection of the condition and/or failure/non-operation. In such embodiments, the data package may include all necessary data to initiate the lease process and execute the determined process(es) using the associated data. Once the token is generated, the token may be communicated to communication device 130 by communication device 110 or service provider server 150. Thus, on failure or non-operation of communication device 110, the token may be used by communication device 130 to execute and/or complete the process(es) of communication device 110 prior to failure. In certain embodiments, prior to transmission of the token, device leasing application 120 may be utilized to agree to terms of leasing communication device 130 and/or negotiate a fee, as well as provide payment for the fee, for example, using an account with service provider server 150.

Device leasing application 120 may be utilized to establish and/or maintain a user account, payment account, digital wallet, and/or other online or virtual account with service provider server 150. The account may be used to pay for leasing of communication device 110, as well as set preferences for use or leasing of nearby devices, parameters for failure/non-operation of the device, when to generate a token, and other user preferences. In this regard, device leasing application 120 may present an interface to a user of communication device 110, where the interface allows the user to establish an account and provide account information, including authentication credentials. Such account may include a personal, device, or other identifier or token, including a generated token by the service or entity (e.g., service provider server 150) or a token provided by the user (e.g., name, username, account identifier, image, digital certificate, etc.). Once authenticated, device leasing application 120 may be utilized to perform, engage in, and/or utilize the various services of service provider server 150. Additionally, device leasing application 120 may utilize this authentication, or other authentication (e.g., a biometric such as a fingerprint or retinal scan, username and password, PIN, etc.) for authentication of the first user on communication device 130 to utilize the token and/or continue the process(es) and associated data.

Device application 112 may correspond to one or more processes to execute modules and associated devices of communication device 110 to execute an application and associated processes of communication device 110, as well as generate process data. In this regard, device application 112 may correspond to specialized hardware and/or software utilized by communication device 110 to execute a device application, which may be utilized to perform various online and/or virtual actions, including electronic transaction processing, messaging, merchant shopping and purchasing, social networking, and other types of electronic actions. For example, device application 112 may correspond to messaging applications (e.g., email, SMS/MMS, instant messaging, and/or social networking messaging), Internet browsers (e.g., browser histories and online interactions), Internet search engines, social networking applications, microblogging applications, merchant and shopping applications, travel applications (e.g., travel fare reservation and purchasing applications including air travel, as well as local travel applications for utilizing subways, taxis, car rentals, and other transportation local to the user), and/or mapping applications. Device application 112 may correspond to media viewing/sharing applications, video games, word processors and associated applications, and/or other types of modules, processes, and applications. Device application 112 may also correspond to an application for biometrics, exercise data, and/or nutritional information, which may be input by the user and/or captured with the assistance of a connected device, such as a pedometer (e.g., a FITBIT® or similar device using a short range wireless communication with communication device 110). Device application 112 may interface with another online or electronic entity to execute processes, such as merchant device 112. Device application 112 may interface with device leasing application 120 for determination of process(es) and associated data executing on communication device 110 when a condition of future non-operation of failure is detected.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 180, or other types of applications. Other applications 114 may also include additional communication applications, such as email, texting, voice, and IM applications that allow a user to send and receive emails, calls, texts, and other notifications through network 180. In various embodiments, other applications 114 may include financial applications, such as banking, online payments, money transfer, or other applications. Other applications 114 may also include other location detection applications, such as a mapping, compass, and/or GPS application, which may be used to determine a location for the user that is communicated to payment provider server 130. Other applications may include social networking applications and/or merchant applications. Other applications 114 may include device interfaces and other display modules that may receive input and/or output information. For example, other applications 114 may contain software programs, executable by a processor, including a graphical user interface (GUI) configured to provide an interface to the user. Other applications 114 may be monitored by device leasing application 120 in order to determine process(es) and associated data at or near a time of failure/non-operation of communication device 110.

Communication device 110 may further include database 116 stored to a transitory and/or non-transitory memory of communication device 110, which may store various applications and data and be utilized during execution of various modules of communication device 110. Thus, database 116 may include, for example, identifiers (IDs) such as operating system registry entries, cookies associated with device application 112 and/or other applications 114, IDs associated with hardware of communication device 110, or other appropriate IDs, such as IDs used for payment/user/device authentication or identification. Database 116 may include data for conditions of future non-operation/failure, process(es) and associated data executing on communication device 110 at or nearby the conditions of failure, a nearby selected device (e.g., communication device 130), leasing information for the nearby device, and/or a generated token.

Communication device 110 includes at least one communication module 118 adapted to communicate with communication device 130 and/or service provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Communication device 130 may be implemented as a communication device that may utilize appropriate hardware and software configured for wired and/or wireless communication with communication device 110, service provider server 150, and/or merchant device 170. For example, in one embodiment, communication device 130 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Communication device 130 may correspond to and be utilized by a second user, such as a lessor or provider for communication device 130. In this regard, communication device 130 may correspond to a leased device, where operations, processes, and executable code may be provided from communication device 110 using a token and performed using communication device 110. Although a communication device is shown, the communication device may be managed or controlled by any suitable processing device. Although only one communication device is shown, a plurality of communication devices may function similarly.

Communication device 130 of FIG. 1 contains a device leasing application 140, a device application 132, other applications 134, a database 136, and a communication module 138. Device leasing application 140, device application 132, and other applications 134 may correspond to executable processes, procedures, and/or applications with associated hardware. In other embodiments, communication device 130 may include additional or different modules having specialized hardware and/or software as required.

Device leasing application 140 may correspond to one or more processes to execute modules and associated devices of communication device 130 to receive a token when communication device 110 is failing or has failed or otherwise becomes inoperable, and utilize the token to adjust device application 132 of communication device 130 to execute and complete the process(es) with process/application data associated with the token. In this regard, device leasing application 132 may correspond to specialized hardware and/or software utilized by communication device 130 to first receive the token from communication device 110 and/or service provider server 130 when or after communication device 110 has been detected or predicted to fail or become inoperable, is susceptible to failure or non-operation, or has failed/become inoperable. Device leasing application 140 may correspond to a general browser application configured to retrieve, present, and communicate information over the Internet (e.g., utilize resources on the World Wide Web) or a private network. For example, device leasing application 140 may provide a web browser, which may send and receive information over network 180, including retrieving website information, presenting the website information to the user, and/or communicating information to the website. However, in other embodiments, device leasing application 140 may include a dedicated application of service provider server 150 or other entity (e.g., payment provider, etc.), which may be configured to provide services through the application.

After receipt of the token, device leasing application 140 may be used to determine and/or retrieve the data for the process(es) and process/application data that is associated with the token. For example, the token may correspond to a data package having the process(es) and associated data. In such embodiments, the data package may include all necessary data to initiate the lease process and execute the determined process(es) using the associated data by device leasing application 140. However, in other embodiments, the token may correspond to an identifier (ID), such as a universally unique identifier (UUID), that uniquely identifies the information for the process(es) and associated data stored with communication device 110 and/or service provider server 150. In such embodiments, the token may therefore only include the ID, or may include the ID with a process to activate communication device 130 and initiate a leasing process (as well as include leasing information, such as information for the first user). Thus, device leasing application 140 may process the token by retrieving the information for the process(es) and associated data from one or more of communication device 110 and/or service provider server 150. In various embodiments, the second user of communication device 130 may be required to approve the use of communication device 130, the use of the token, and/or the execution of the process, for example, through input to a device interface (e.g., a confirmation interface). Moreover, the confirmation interface may allow the second user to set parameters for use, such as an amount of time, amount of battery or processing use, an amount of usable memory, usable processes of communication device 130, and/or a fee (e.g., flat or variable) for use of communication device 130. The interface may allow for negotiation of such lease parameters. Additionally, where communication device 130 will utilize memory space, processing components, or other features for the process(es), device leasing application 140 may require approval by the second user. The second user may further be required to agree to downloading an application where the process(es) require the application for completion. Device leasing application 140 may be used to locate, download, and install the applications where required.

In various embodiments, prior to utilizing or otherwise retrieving the process(es) and associated data, device leasing application 140 may require that the first user for communication device 110 authenticate themselves and/or their identity or account. In this regard, the token may include required authentication and/or an authentication process. Thus, in order to first retrieve the process(es) and associated data, or execute the process(es) using the associated data, the first user may be required to authenticate with a username, password, PIN, or biometric (e.g., fingerprint) on communication device 130. Device leasing application 140 may confirm the authentication, and may then configure device application 132 using the process(es) and associated data. Additionally, device leasing application 140 may store, hide, and/or encrypt the data within an application of the second user required for execution of the process(es) using the associated data of the first user. For example, the second user may utilize an application of communication device, which may have user data for the second user, such as account information, application data, messages, digital content, and other information. On processing of the token, device leasing application 140 may secure the data from viewing and/or use by the first user while the first user utilizing the application to execute and complete the process(es) using the associated data of the first user (e.g., while leasing communication device 130). The secure data may be accessed and utilized with the application after the first user completes use of communication device 110, for example, when the first or second user end the leasing process (e.g., based on a leased amount of time, data usage, device usage, or selects to exits through a menu option). Additionally, the process(es) and data of the first user may be wiped or otherwise erased or deleted by device leasing application 140 from communication device 130 to prevent viewing and use by the second user after the first user has completed use of leasing communication device 130.

Device leasing application 140 may be utilized to establish and/or maintain a user account, payment account, digital wallet, and/or other online or virtual account with service provider server 150. The account may be used to receive payment for leasing of communication device 130, as well as set preferences for use or leasing of communication device 130. In this regard, device leasing application 140 may present an interface to a user of communication device 130, where the interface allows the user to establish an account and provide account information, including authentication credentials. Such account may include or be associated with a personal, device, or other identifier or token, including a generated token by the service or entity (e.g., service provider server 150) or a token provided by the user (e.g., name, username, account identifier, image, digital certificate, etc.). Once authenticated, device leasing application 140 may be utilized to perform, engage in, and/or utilize the various services of service provider server 150. Device leasing application 140 may also display or provide information for communication device 110 and/or the second user for communication device 130 to the second user through an output component of communication device 130. The information may allow the second user to locate or recognize the first user, such as a map location, landmark, image of the first user, name, contact information, meeting place, or other user, location, or device information.

Once the process(es) and associated data are ready for execution, device leasing application 140 may configure device application 132 using the process(es) and associated data. As previously discussed, previous application data of the other user may be removed, stored, encrypted, or otherwise protected. Additionally, device leasing application 140 may load the process(es) and associated data into device application 132 for use by the first user. The second user may be required to agree to the leasing, or the leasing may begin automatically on selection of a menu option and/or authentication by the first user. The process(es) and associated data may then load into device application 132 so that device application 132 is in a state similar to the state of device application 112 when the condition of failure/non-operation is detected and/or occurs.

Thus, device application 132 may correspond to one or more processes to execute modules and associated devices of communication device 130 to execute an application and associated processes of communication device 130 in order to perform the process(es) and associated data for the first user of communication device 110. In this regard, device application 132 may correspond to specialized hardware and/or software utilized by communication device 130 to execute a device application, which may be utilized to perform various online and/or virtual actions, including electronic transaction processing, messaging, merchant shopping and purchasing, social networking, and other types of electronic actions. For example, device application 132 may correspond to messaging applications (e.g., email, SMS/MMS, instant messaging, and/or social networking messaging), Internet browsers (e.g., browser histories and online interactions), Internet search engines, social networking applications, microblogging applications, merchant and shopping applications, travel applications (e.g., travel fare reservation and purchasing applications including air travel, as well as local travel applications for utilizing subways, taxis, car rentals, and other transportation local to the user), and/or mapping applications. Device application 132 may correspond to media viewing/sharing applications, video games, word processors and associated applications, and/or other types of modules, processes, and applications. Device application 132 may also correspond to an application for biometrics, exercise data, and/or nutritional information, which may be inputted by the user and/or captured with the assistance of a connected device, such as a pedometer (e.g., a FITBIT® or similar device using a short range wireless communication with communication device 130). Device application 132 may execute the process(es) and associated data for the token using the features of device application 132.

In various embodiments, communication device 130 includes other applications 134 as may be desired in particular embodiments to provide features to communication device 130. For example, other applications 134 may include security applications for implementing client-side security features, programmatic client applications for interfacing with appropriate application programming interfaces (APIs) over network 180, or other types of applications. Other applications 134 may also include additional communication applications, such as email, texting, voice and IM applications that allow a user to send and receive emails, calls, texts, and other notifications through network 180. In various embodiments, other applications 134 may include financial applications, such as banking, online payments, money transfer, or other applications. Other applications 134 may also include other location detection applications, such as a mapping, compass, and/or GPS application, which may be used to determine a location for the user that is communicated to payment provider server 130. Other applications may include social networking applications and/or merchant applications. Other applications 134 may include device interfaces and other display modules that may receive input and/or output information. For example, other applications 134 may contain software programs, executable by a processor, including a graphical user interface (GUI) configured to provide an interface to the user. Other applications 134 may be monitored by device leasing application 140 in order to determine process(es) and associated data at or nearby a time of failure/non-operation of communication device 130.

Communication device 130 may further include database 136 stored to a transitory and/or non-transitory memory of communication device 130, which may store various applications and data and be utilized during execution of various modules of communication device 130. Thus, database 136 may include, for example, identifiers (IDs) such as operating system registry entries, cookies associated with device application 132 and/or other applications 134, IDs associated with hardware of communication device 130, or other appropriate IDs, such as IDs used for payment/user/device authentication or identification. Database 136 may include a received token, as well as process(es) and associated data for execution on communication device 130.

Communication device 130 includes at least one communication module 138 adapted to communicate with communication device 110, service provider server 150, and/or merchant device 170. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 150 may be maintained, for example, by an online service provider, which may provide leased device services for the first user associated with communication device 110 and the second user associated with communication device 130. In this regard, service provider server 150 includes one or more processing applications which may be configured to interact with communication device 110, communication device 130, and/or another device/server to facilitate leasing of devices. In one example, service provider server 150 may be provided by PAYPAL®, Inc. of San Jose, Calif., USA. However, in other embodiments, service provider server 150 may be maintained by or include a financial service provider, social networking service, email or messaging service, media sharing service, and/or other service provider, which may provide device leasing services, for example, for the use of an application and/or account.

Service provider server 150 of FIG. 1 includes a leased devices application 160, a service provider application 152, other applications 154, a database 156, and a network interface component 158. Leased devices application 160, service provider application 152, and other applications 154 may correspond to executable processes, procedures, and/or applications with associated hardware. In other embodiments, service provider server 150 may include additional or different modules having specialized hardware and/or software as required.

Leased devices application 160 may correspond to one or more processes to execute modules and associated specialized hardware of service provider server 150 to provide services for use in leasing communication device 130 by the first user associated with communication device 110 in the event of a predicted failure or other non-operation of communication device 110. Note that failure, non-operation or similar descriptions of the communication device generally refers to the communication device being unable to perform or complete an action or process currently being performed by the communication device at a future time and does not require the device to fail completely. In this regard, leased devices application 160 may correspond to specialized hardware and/or software to perform one or more of the processes described in references to device leasing application 120 of communication device 110 and/or device leasing application 140 of communication device 130. For example, leased devices application 160 may instead be used to allow users to establish accounts and/or set preferences for leasing of devices. Such preferences may correspond to detect, selection, and use of nearby devices in the event of a failure (e.g., lessee preferences, such as those for the first user of communication device 110), or preferences for the allowance of use of a communication device by another user (e.g., lessor preferences, such as those for the second user of communication device 130). Additionally, leased devices application 160 may be used for detection of a condition of future failure/non-operation of communication device 110, determination of process(es) in use on communication device 110, identification of communication device 130 as the device for lease, generation of a token identifying the process(es), and communication of the token to communication device 130. Where payment is due for lease of communication device 130, leased devices application 160 may further be used to process a payment, for example, using a payment account for the first user and made to a payment account of the second user. The payment accounts may correspond to online financial accounts, and may be linked to user bank accounts, payment cards, or other financial accounts for use in processing payments.

Service provider application 152 may correspond to one or more processes to execute modules and associated specialized hardware of service provider server 150 to receive and/or transmit information from communication device 110 for establishing an account or utilizing another service of service provider server 150. In this regard, service provider application 152 may correspond to specialized hardware and/or software to establish an account, for example, a payment account, which may be utilized to send and receive payments and monetary transfers and engage in other financial transactions. Other types of accounts may correspond to messaging, social networking, media sharing, microblogging, and other types of accounts associated with a provided service. A user associated with communication device 110 may establish an account with service provider application 152 by providing personal and/or financial information to service provider server 150 and selecting an account login, password, and other authentication information. The account may be accessed and/or used through a browser application and/or dedicated payment application executed by communication device 110. In order to authenticate an identity of a user and/or for use of the account, service provider application 152 may authenticate the user for use of the account and/or identity. Once authenticated, service provider application 152 may be utilized to use various services provided by service provider server 150, such as payment, social networking, messaging, or other available service.

In various embodiments, service provider server 150 includes other applications 154 as may be desired in particular embodiments to provide features to payment provider server 150. For example, other applications 154 may include security applications for implementing server-side security features, programmatic client applications for interfacing with appropriate application programming interfaces (APIs) over network 180, or other types of applications. Other applications 154 may contain software programs, executable by a processor, including a graphical user interface (GUI), configured to provide an interface to the user when accessing payment provider server 134. In various embodiments where not provided by service provider application 152, other applications 154 may include connection and/or communication applications, as well as user account applications, which may be utilized by the user associated with communication device 110.

Additionally, service provider server 150 includes database 156. Accounts in database 156 may include entity information, such as name, address, birthdate, payment/funding information, additional user financial information, and/or other desired user data. The entity may link to their respective accounts through an account, user, merchant, and/or device ID, as well as a generated token, which may be provided to communication device 130 for use. Thus, when an ID is transmitted to service provider server 150, e.g., from communication device 110, an account belonging to the entity may be found. Additional data used in leasing one or more devices may be stored to database 156.

In various embodiments, service provider server 150 includes at least one network interface component 158 adapted to communicate with communication device 110 and/or communication device 130 over network 180. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Merchant device 170 may be maintained, for example, by a merchant that provides electronic sales to users through communication device 110 and/or communication device 130. In this regard, merchant device 170 may include a device having processing applications, which may be configured to interact with communication device 110 and/or communication device 130 to engage in transactions. Merchant device 170 may be implemented using any appropriate hardware and software configured for wired and/or wireless communication with communication device 110 and/or communication device 130. For example, in one embodiment, merchant device 170 may be implemented as a single or networked personal computer (PC), a smart phone, laptop computer, wearable computing device, and/or other types of computing devices at a merchant location capable of transmitting and/or receiving data. Although a merchant device 170 is shown, the merchant device 170 may be managed or controlled by any suitable processing device. Although only one merchant device 170 is shown, a plurality of merchant devices 170 may function similarly.

Merchant device 170 of FIG. 1 contains a sales application 172, other applications 174, a database 176, and a communication module 178. Sales application 172 and other applications 174 may correspond to processes, procedures, and/or applications executable by a hardware processor, for example, a software program. In other embodiments, merchant device 170 may include additional or different modules having specialized hardware and/or software as required.

Sales application 172 may correspond to one or more processes to execute modules and associated specialized hardware of merchant device 170 that provide sales, checkout, and payment processes for a transaction to purchase one or more items for sale from the merchant corresponding to merchant device 170. In this regard, sales application 172 may correspond to specialized hardware and/or software of merchant device 170 to provide a convenient interface to permit a merchant to enter, view, and/or edit items and/or services for purchase by user 102. For example, sales application 172 may be implemented as an application having a user interface enabling the merchant to enter item information and request payment for a transaction on checkout/payment of one or more items/services. In certain embodiments, sales application 172 may correspond more generally to a web browser configured to view information available over the Internet or access a website corresponding to the merchant and/or payment provider server 140. Thus, sales application 172 may provide item sales through an online marketplace using the website of the merchant. Thus, the first user of communication device 110 may initiate a transaction using sales application 172.

Once a payment amount is determined for a transaction for items to be purchased by user, sales application 172 may request payment from the first user. The provided payment information may be communicated to merchant device 170 with the transaction and transaction information for approval. A payment provider server may process the transaction with the provided payment information and determine whether to approve or decline the transaction using a payment instrument for the payment process used with the acceptance mechanism. Sales application 172 may then receive the results of the transaction processing, and complete the transaction with the first user, for example, by providing the user the items for the transaction or declining the transaction where the user is not authenticated or the transaction is not authorized (e.g., insufficient funds). As discussed herein, communication device 110 may be used to initiate and process the transaction. However, communication device 110 may fail at some point prior to completion of the transaction. Thus, the process(es) used in the transaction may be mirrored on communication device 130 using the procedures discussed herein. This allows the first user to use communication device 130 to complete the transaction processing with sales application 172.

Merchant device 170 includes other applications 174 as may be desired in particular embodiments to provide features to merchant device 170. For example, other applications 174 may include security applications for implementing client-side security features, programmatic client applications for interfacing with appropriate application programming interfaces (APIs) over network 180, or other types of applications. Other applications 174 may also include email, texting, voice and IM applications that allow a user to send and receive emails, calls, texts, and other notifications through network 180. In various embodiments, other applications 174 may include financial applications, such as banking, online payments, money transfer, or other applications associated with communication device 130. Other applications 174 may contain software programs, executable by a processor, including a graphical user interface (GUI) configured to provide an interface to the user.

Merchant device 170 may further include database 176 which may include, for example, identifiers such as operating system registry entries, cookies associated with sales application 172 and/or other applications 174, identifiers associated with hardware of merchant device 170, or other appropriate identifiers, such as identifiers used for payment/user/device authentication or identification. Identifiers in database 176 may be used by a payment/credit provider to associate merchant device 170 with a particular account maintained by the payment/credit provider. Database 176 may further include transaction information and/or results.

Merchant device 170 includes at least one communication module 178 adapted to communicate with communication device 110 and/or communication device 130. In various embodiments, communication module 178 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Network 180 may be implemented as a single network or a combination of multiple networks. For example, in various embodiments, network 180 may include the Internet or one or more intranets, landline networks, wireless networks, and/or other appropriate types of networks. Thus, network 180 may correspond to small scale communication networks, such as a private or local area network, or a larger scale network, such as a wide area network or the Internet, accessible by the various components of system 100.

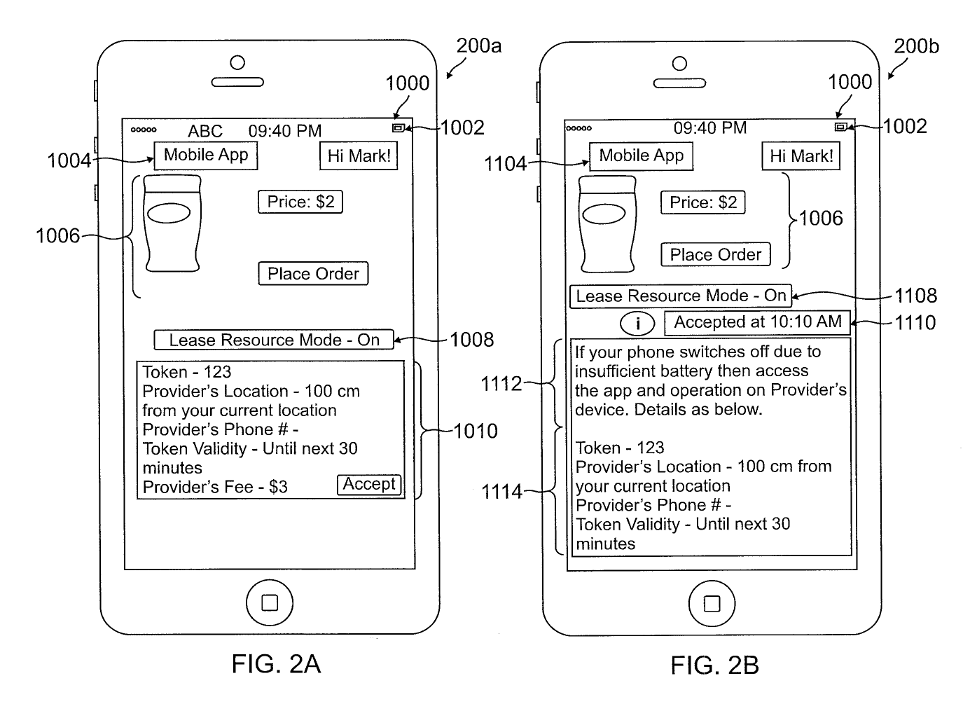

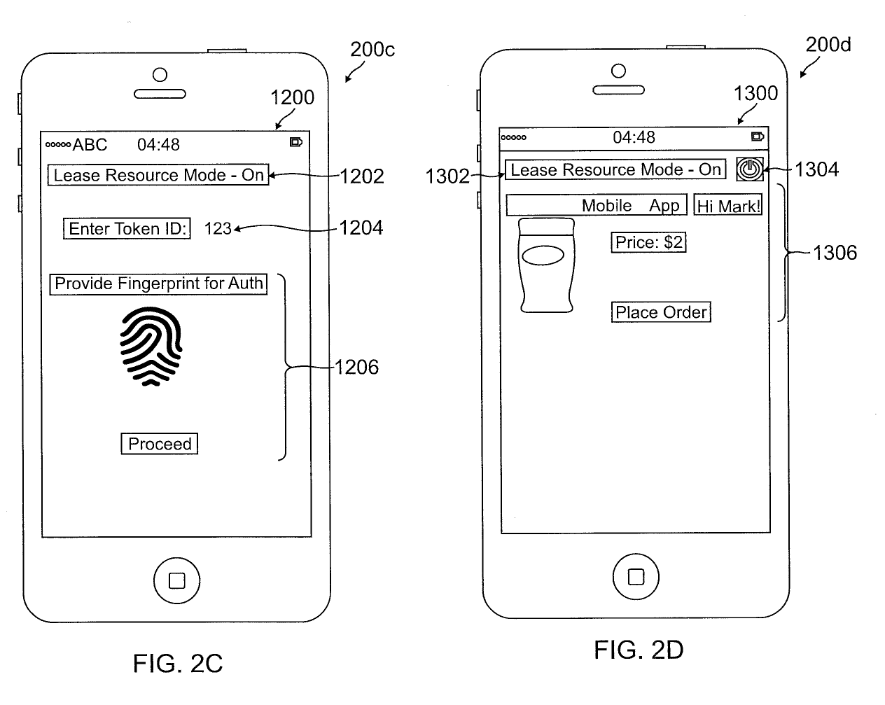

FIG. 2A is an exemplary environment displaying a communication device prior to failure and establishing a token for leased computing on a nearby device, according to an embodiment. Environment 200a of FIG. 2A includes an interface 1000 corresponding to an interface of a communication device, such as communication device 110 in environment 100 of FIG. 1. In this regard, interface 1000 may correspond to an interface of a lessee's, requestor's, or first user's device prior to failure after detecting a condition of future non-operation.

Interface 1000 of environment 200a displays various information on detection of a condition of future non-operation or failure, including information used to lease another device. For example, an icon 1002 displays information relating to operation of the communication device, which may correspond to a current battery level. Interface 1000 also includes a process 1004 currently executing on the device, which corresponds to a mobile application. The user utilizing the communication device in environment 200a may currently be viewing an item for purchase in process 1004, such as item 1006. Item 1006 may correspond to data currently in process 1004.

A mode 1008 has been activated within interface 1000 in order to protect process 1004 from failure and becoming incomplete. For example, mode 1008 allows for establishing a token to lease another device in the event of failure or non-operation of the communication device in environment 200a. Thus, once mode 1008 is activates, information 1010 is displayed that is used to lease another device for use in the event of non-operation of failure. Information 1010 displays a generated token based on the leasing information for the device for lease in information 1010. For example, the leasing information includes a location of the device for lease, a contact number, a token validity period, and a lease fee.

FIG. 2B is an exemplary environment displaying acceptance of leased computing on a nearby device by a communication device in danger of failure, according to an embodiment. Environment 200a of FIG. 2A includes an interface 1100 corresponding to an interface of a communication device, such as communication device 110 in environment 100 of FIG. 1. In this regard, interface 1100 may correspond to an interface of a lessee's, requestor's, or first user's device prior to failure after detecting a condition of future non-operation.

Thus, in environment 200b, the communication device is set to lease another device if the communication device becomes inoperable or fails. For example, an icon 1102 in interface 1100 may continue displaying parameters for operation of the communication device, where the battery level displayed may drop to zero in the event of failure of the communication device. Process 1004 may be monitored and updated so that process 1004 having item 1106 may be continued on the leased device. A mode 1108 may be continued, where the mode shows acceptance 1110 of leasing terms to lease another device in the event of failure of the communication device in environment 200b. Thus, failure text 1112 alerts the user of the process to obtain the leased device shown in information 1114 when the communication device fails.

FIG. 2C is an exemplary environment displaying an authentication process to allow for execution of the leased computing processes on a leased device, according to an embodiment. Environment 200a of FIG. 2A includes an interface 1200 corresponding to an interface of a communication device, such as communication device 130 in environment 100 of FIG. 1. In this regard, interface 1200 may correspond to an interface of a lessor's, provider's, or second user's device after failure or non-operation of a lessee's, requestor's, or first user's device.

In environment 200c, the communication device of FIG. 2A and FIG. 2B has failed, and the leased device to continue process 1004 and process 1104 of FIG. 2A and FIG. 2B, respectively, is shown. However, prior to utilizing the token and continuing the processes of the failed communication device, interface 1200 may require authentication of the identity of the lessee, requestor, or first user wishing to use the communication device to continue the process. For example, a mode 1202 is activated to allow the communication device in environment 200c be leased to another user. A token 1204 is shown, which may correspond to the token identifier for the token of the lessee, requestor, or first user. In order for the lessee, requestor, or first user to utilize token 1204, however, the lessee, requestor, or first user may be required to complete authentication process 1206, shown as requiring a fingerprint of the leasee, requestor, or first user.

FIG. 2D is an exemplary environment displaying execution of leased computing processes on a leased device after authentication of a user, according to an embodiment. Environment 200a of FIG. 2A includes an interface 1300 corresponding to an interface of a communication device, such as communication device 130 in environment 100 of FIG. 1. In this regard, interface 1300 may correspond to an interface of a lesssor's, provider's, or second user's device after failure or non-operation of a lessee's, requestor's, or first user's device.

Once authenticated through authentication process 1206 of FIG. 2C, environment 200d shows interface 1300 having the continued process from the failed device. For example, mode 1302 allows for leasing of the communication device in environment 200d to complete process 1306. Process 1306 may correspond to process 1004 and process 1104 of FIG. 2A and FIG. 2B, respectively. Process 1306 may further utilize item 1006 and item 1106 of FIG. 2A and FIG. 2B, respectively, as the process data. Thus, the lessee, requestor, or first user may continue the process of the failed device on a leased device. Additionally, the lessee, requestor, or first user may end the process and wipe their data using a quit function 1304.

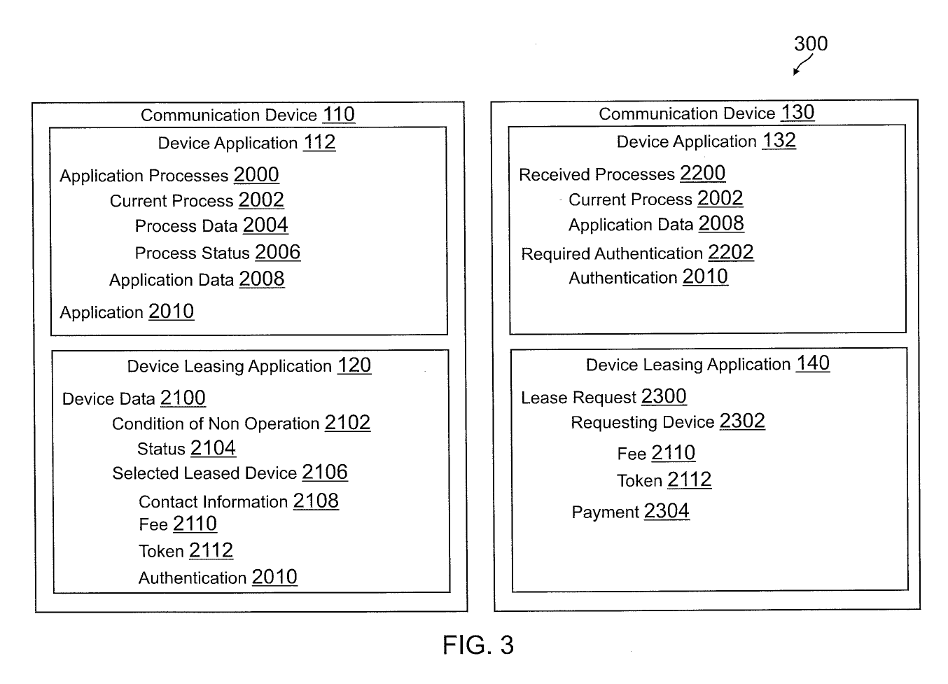

FIG. 3 is an exemplary system environment having two communication devices for leased device operations to a nearby device on detection of device inoperability, according to an embodiment. Environment 300 of FIG. 3 includes a communication device 110, a communication device 130, and a service provider server 150 corresponding generally to the described devices and associated features found in system 100 of FIG. 1.

Communication device 110 executes a device application 112 corresponding generally to the specialized hardware and/or software modules and processes described in reference to FIG. 1. In this regard, device application 112 includes one or more processes in execution on communication device 110 and/or in use by a user of communication device 110 at or prior to failure and/or non-operation of communication device 110. For example, device application 112 may include application processes 2000, which may correspond all processes available in device application 112. Current process 2002 may be in execution on communication device 110 at or prior to the failure or non-operation, or on detection of a condition of failure/non-operation. Thus, current process 2002 further includes process data 2004, as well as process status 2006 (e.g., a place in the process, completion amount, etc.). Current process 2002 may further be associated with application data 2008 currently in execution by device application 112 during current process 2002. Additionally, device application 112 may require an authentication 2010, which may further be used on another device leased to execute and/or complete current process 2002 and application data 2008.

Communication device 110 also executes a device leasing application 120 corresponding generally to the specialized hardware and/or software modules and processes described in reference to FIG. 1. In this regard, device leasing application 120 includes information used to determine that another device (e.g., communication device 130) is required to be leased. For example, device leasing application 120 may read device data 2100, which includes a condition of non-operation 2102 that may cause failure or non-operation of communication device 110, as well as a status 2104 (e.g., time until failure/non-operation). Device data 2100 further includes a selected leased device 2106, which may include contact information 2108, a fee 2110, a token 2112 generated to lease the device, and authentication 2010 for use of current process 2002 and application data 2008.

Communication device 130 executes a device application 132 corresponding generally to the specialized hardware and/or software modules and processes described in reference to FIG. 1. In this regard, device application 132 includes data for received process(es) and associated data to execute on communication device 130 using device application 132. For example, device application 132 may be leased for use by the user of communication device 110 when communication device 110 has failed. Thus, device application 132 includes received processes 2200 for execution, including current process 2002 and application data 2008. Additionally, require authentication 2202 may be required for unlocking and utilizing received processes 2200, which may correspond to authentication 2010 from communication device 110.

Communication device 130 also executes a device leasing application 140 corresponding generally to the specialized hardware and/or software modules and processes described in reference to FIG. 1. In this regard, device leasing application 140 includes information received from communication device 110 for use in leasing communication device 130 to continue processes of device application 112 in the event of failure or non-operation of communication device 110. Thus, device leasing application 140 includes a lease request 2300, which includes a requesting device 2302, as well as fee 2110 from communication device 110, and token 2112 from communication device 110. A payment 2304 may also be provided for fee 2110, where device leasing application 140 may monitor a status for payment 2304.

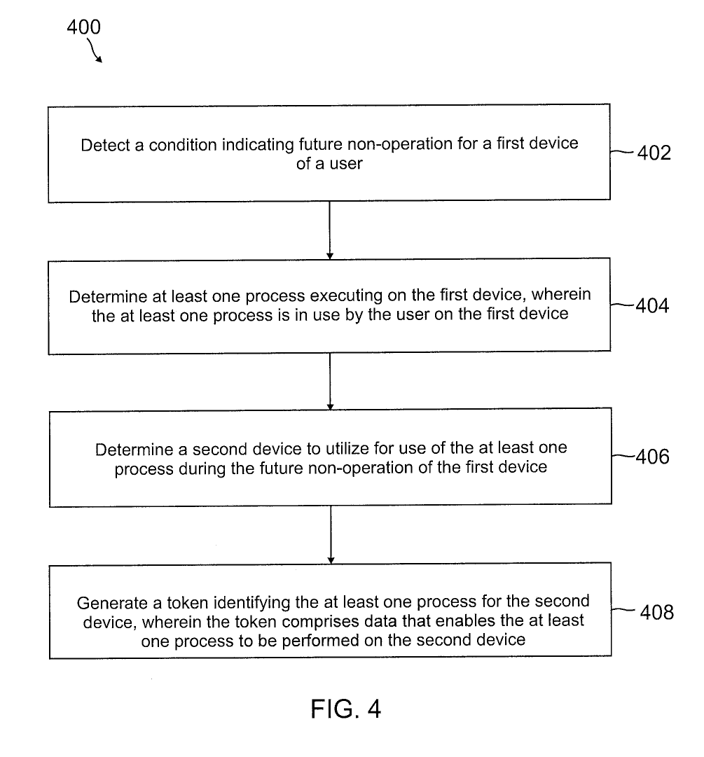

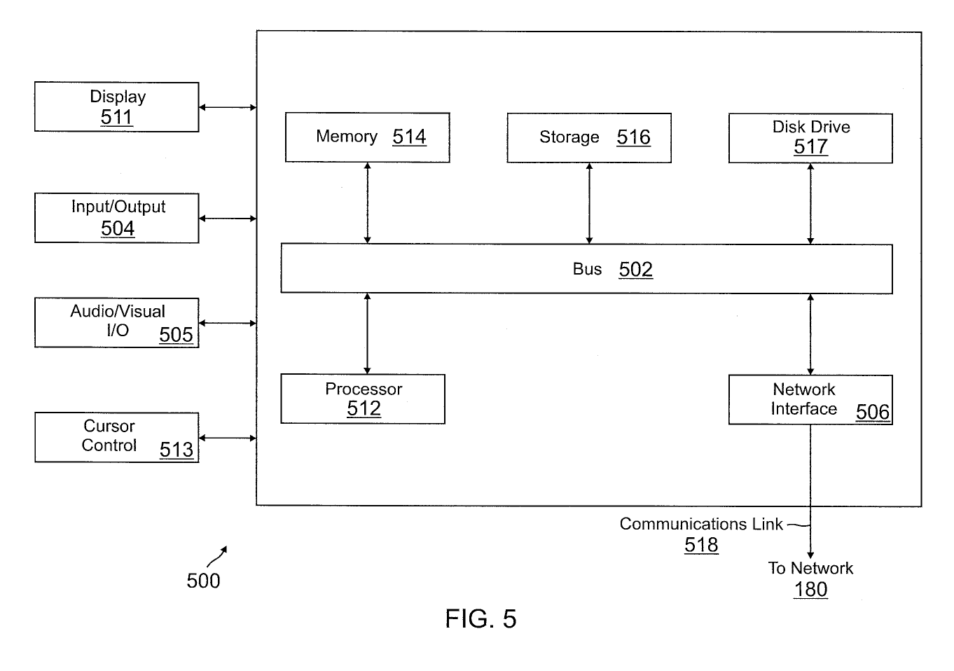

FIG. 4 is an exemplary process flowchart for leased device operations to a nearby device on detection of device inoperability, according to an embodiment. Note that one or more steps, processes, and methods described herein may be omitted, performed in a different sequence, or combined as desired or appropriate.

At step 402, a condition indicating future non-operation for a first device of a first user is detected or determined. The condition may comprise at least one of a low battery for the first device, no communication signal or low communication signal for the first device, damage to the first device, a software update for the first device, a firmware update for the first device, a hardware update or replacement for the first device, lack of memory storage for the first device, and an application corruption of an application executing on the first device

At step 404, at least one process executing on the first device is determined, wherein the at least one process is in use by the first user on the first device. At step 406, a second device to utilize for use of the at least one process during the future non-operation of the first device is determined. In various embodiments, determining the second device may comprises determining a first location of the first device and determining that the second device is within a set proximity to the first device. In other embodiments, determining the second device may comprise communicating, by the first device, with the second device using short range wireless communications. In still further embodiments, determining the second device may comprise determining the second device is available to lease for the use of the at least one process, wherein the lease comprises a payment by the first user to a second user of the second device for the use of the at least one process. An online service provider or an online payment provider may process the payment to the second user using an account of the first user with the online service provider or the online payment provider.

Moreover, in the aforementioned embodiments, determining the second device may comprise determining a plurality of devices for use of the at least one process, wherein the second device is one of the plurality of devices. For example, the second device may be selected from the plurality of devices based on one of user input by the first user to the first device and preferences for non-operation of the first device set by the first user. Additionally, it may be required that determining the second device comprises determining that the second device has an application for the at least one process or supports the at least one process. Where the second device does not have the application or support the at least one process, the second device may download the necessary applications or features.

At step 408, a token identifying the at least one process for the second device is generated, wherein use of the token loads the at least one process on the second device, for example, where the token comprises data that enables the at least one process to be performed on the second device. The token may further comprise authentication information for the first user, wherein the authentication information comprises at least one authentication credential required for access or use of the at least one process on the second device. The authentication credentials or information may comprise a biometric identifier for the user. Additionally, the first user may be required to enter such credentials on the second device.

At step 410, the token is communicated to the second device. The token may be communicated to the second device through the short range wireless communications. Additionally, a second user for the second device may be identified to the first user through identification information provided to the first device before the future non-operation. Additionally, the second device may determine current application data for an application on the second device utilizing the at least one process, wherein the second device stores the current application data with the second device during executing of the at least one process on the second device. Moreover, the first or second user may exit from processing the at least one process through an interface or menu command in the second device.

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 180. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims. cm What is claimed is:

1. A communication device system comprising:
a non-transitory memory; and
one or more hardware processors coupled to the non-transitory memory and configured to read instructions from the non-transitory memory to cause the communication device system to perform operations comprising:
detecting a condition indicating future non-operation for a first device of a first user;
determining at least one process executing on the first device, wherein the at least one process is in use by the first user on the first device;
determining a second device to utilize for the use of the at least one process during the future non-operation of the first device;
generating a token corresponding to the at least one process for the second device, wherein the token comprises data that enables the at least one process to be performed on the second device; and
communicating the token to the second device.

2. The communication device system of claim 1, wherein determining the second device to utilize for the use of the at least one process comprises:
determining a first location of the first device; and
determining that the second device is within a set proximity to the first device.

3. The communication device system of claim 1, wherein determining the second device to utilize for the use of the at least one process comprises:
communicating, by the first device, with the second device using short range wireless communications,
wherein the token is communicated to the second device through the short range wireless communications.

4. The communication device system of claim 1, wherein the token further comprises authentication information for the first user, and wherein the authentication information comprises at least one authentication credential required for access or use of the at least one process on the second device.

5. The communication device system of claim 1, wherein determining the second device to utilize for the use of the at least one process comprises:
determining the second device is available to lease for the use of the at least one process, wherein the lease comprises a payment by the first user to a second user of the second device for the use of the at least one process.

6. The communication device system of claim 5, wherein an online service provider or an online payment provider processes the payment to the second user using an account of the first user with the online service provider or the online payment provider.

7. The communication device system of claim 1, wherein the condition comprises at least one of a low battery for the first device, no communication signal or low communication signal for the first device, damage to the first device, a software update for the first device, a firmware update for the first device, a hardware update or replacement for the first device, lack of memory storage for the first device, and an application corruption of an application executing on the first device.

8. The communication device system of claim 1, wherein a second user for the second device is identified to the first user through identification information provided to the first device before the future non-operation.

9. The communication device system of claim 1, wherein the second device determines current application data for an application on the second device utilizing the at least one process, and wherein the second device stores the current application data with the second device during executing of the at least one process on the second device.

10. The communication device system of claim 1, wherein determining the second device to utilize for the use of the at least one process comprises:
determining a plurality of devices for use of the at least one process,
wherein the second device is one of the plurality of devices.

11. The communication device system of claim 10, wherein the second device is selected from the plurality of devices based on one of user input by the first user to the first device and preferences for non-operation of the first device set by the first user.

12. A method comprising:
determining that a parameter of a first device of a user indicates a possible failure of the first device within a set timeframe;
determining an application executing on the first device and current application data for the application, wherein the current application data is in use by the user on the first device;
determining a second device to process the current application data;
generating a token for retrieval of the current application data, wherein use of the token loads the current application data to the second device; and
communicating the token to the second device.

13. The method of claim 12, wherein the current application data is stored to a service provider server, and wherein the second device retrieves the current application data using the token on authentication of the user on the second device.

14. The method of claim 12, wherein the determining the second device to process the current application data comprises:
determining that the second device supports the application executing on the first device.

15. The method of claim 14, wherein the second device downloads the application on the second device if the second device does not have the application installed on the second device.

16. The method of claim 14, wherein the first user provides authentication credentials to the application executing on the second device to process the current application data in the application executing on the second device.

17. The method of claim 14, wherein the current application data is processed by the application executing on the second device, and wherein a command in an graphic user interface of the second device enters and exits processing the current application data processing in the application executing on the second device.

18. A service provider system comprising:
a non-transitory memory; and
one or more hardware processors coupled to the non-transitory memory and configured to read instructions from the non-transitory memory to cause the service provider system to perform operations comprising:
receiving device information for a first device of a user, wherein the device information comprises a data indicating a possible future non-operation of the first device, wherein the device information further comprises at least one process executing on the first device, wherein the at least one process is in use by the user on the first device;
determining a second device to continue the at least one process if the possible future non-operation of the first device occurs;
generating a token corresponding to the at least one process for the second device, wherein the token comprises data that enables the at least one process to be performed on the second device; and
communicating the token to the second device.

19. The service provider system of claim 18, wherein the token further identifies authentication credentials for the user and required to utilize the at least one process on the second device.

20. The service provider system of claim 19, wherein the authentication credentials comprise a biometric identifier for the user.
